(19) United States
(12) Patent Application Publication
(10) Pub. No.: US 2026/0258788 A1
(43) Pub. Date: Sep. 3, 2026

(54) Floating Systems for Wind Turbines Using Semi-Submersibles

(71) Applicant: Trendsetter Vulcan Offshore, Inc., Houston, TX (US)

(72) Inventor: James V. Maher, Houston, TX (US)

(21) Appl. No.: 18/875,053

(22) PCT Filed: Jun. 13, 2023
(86) PCT No.: PCT/US2023/025204

§ 371 Date: Dec. 13, 2024

Related U.S. Application Data
(60) Provisional application No. 63/351,739, filed on Jun. 13, 2022.

(51) Int. Cl. F03D 13/30; B63B 1/12; B63B 35/28; B63B 35/44; B63B 75/00; F03D 13/10

(52) U.S. Cl. CPC F03D 13/30; B63B 1/125; B63B 35/28; B63B 35/44; B63B 75/00; F03D 13/139; B63B 2035/446; F05B 2230/61; F05B 2240/93; F05B 2240/95

(57) ABSTRACT

Delivery of a high volume of floating systems for wind turbines can involve the standard design of sections, such as “tubes” or “cans,” comprising a rolled plate and ring stiffeners. The delivery can then involve the transportation of the sections in blocks to an assembly site that is closer to the planned installation point. The sections are used to manufacture semi-submersibles at the assembly site using a barge with cranes. The delivery can then involve the transportation of each of the semi-submersibles to a platform, such as a standard jack-up vessel or a crane jacket, near which the semi-submersible is temporarily attached to allow the installation of the Tower, the nacelle, and blades. Finally, the delivery involves the transportation of the completed wind turbine to the planned installation point, where it can be attached to a pile driven into the seafloor or moored during use.

WO

### CROSS-REFERENCE TO RELATED APPLICATIONS

This application claims the benefit of priority to U.S. provisional application Ser. No. 63/351,739, filed on Jun. 13, 2022, which is incorporated herein by reference for all and any purposes.

### FIELD AND BACKGROUND OF THE INVENTION

The disclosure generally relates to off-shore wind turbines and methods of installation thereof. The disclosure relates more specifically to floating systems for wind turbines that use semi-submersible and, methods of installation of off-shore wind turbines, and facilities configured for assembling the off-shore wind turbines.

Shallow water wind technology has been through significant efforts to industrialize the delivery process. In particular, the industry has significant experience using mono-piles and fixed jackets for foundations.

However, the industry has little experience with large-scale floating wind platforms, which may be necessary for the commercialization of off-shore wind technology in locations where the seabed slopes away from the shore rapidly. Also, significant efforts to industrialize the delivery process of large-scale floating wind platforms are still necessary for floating wind technology.

### BRIEF DESCRIPTION OF THE DRAWINGS

For a more detailed description of the embodiments of the disclosure, reference will now be made to the accompanying drawings, wherein:

FIGS. 1A to 1D are perspective views of semi-submersibles suitable for attaching a Tower at or near a corner of the semi-submersibles;

FIGS. 2A to 2C are perspective views of semi-submersibles suitable for attaching a Tower at or near the center of the semi-submersibles;

FIGS. 3 to 9 illustrate a sequence of steps of a method for assembling an off-shore wind turbine; and

FIGS. 10 and 11 illustrate views of first and second assembly sites.

### SUMMARY

The disclosure generally describes an off-shore wind turbine. The off-shore wind turbine may comprise a semi-submersible, a Tower attached to the semi-submersible, and a turbine mounted on top of the Tower.

The semi-submersible may more specifically comprise a primary buoyant vertical column, a first plurality of long horizontal tubes, and a plurality of secondary buoyant vertical columns. Each of the first plurality of long horizontal tubes may have a first end attached to the primary buoyant vertical column at a first level. Each of the plurality of secondary buoyant vertical columns may be connected to a corresponding second end of one of the first plurality of long horizontal tubes. Preferably, the spacings between the primary buoyant vertical columns and each of the plurality of secondary buoyant vertical columns are sufficiently large to accommodate an overturning moment applied in operating conditions by the turbine to the semi-submersible via the Tower. Preferably, the Tower has a base located at least partially directly above the primary buoyant vertical column.

Further, the disclosure generally describes a method of installing the off-shore wind turbine.

The method may comprise the step of constructing a plurality of sections, such as “tubes” or “cans.” Each of the plurality of sections preferably includes a cylindrical plate and a stiffening ring welded inside the cylindrical plate, and two bulkheads. For example, the construction of the plurality of sections may be performed on a barge.

The method may comprise the step of constructing the semi-submersible by welding together the plurality of sections at a first assembly site that is configured to allow the lowering of the semi-submersible into the sea. Then, the semi-submersible may be lowered so that the semi-submersible floats on the sea surface and may be towed to a second assembly site, which is next to a crane.

The method may comprise the step of temporarily securing the semi-submersible next to the crane. The crane may be used to place a base of the Tower at least partially directly above the primary buoyant vertical column. The Tower may be attached to the semi-submersible while the semi-submersible is temporarily secured, and the turbine may be mounted on top of the semi-submersible. Then, the off-shore wind turbine system may be transported to an off-shore usage location.

The method may comprise the step of coupling to the seafloor or mooring the off-shore wind turbine system at the off-shore usage location.

Still further, the disclosure describes an assembly facility.

The assembly facility comprises a barge or platform. The barge or platform is generally adapted for raising or lowering a dry dock at a first assembly site. The barge or platform includes a pier at a second assembly site, and a plurality of lift structures are mounted on the barge or platform. At least one of the plurality of lift structures is located on the pier.

### DETAILED DESCRIPTION

It is to be understood that the following disclosure describes several exemplary embodiments for implementing different features, structures, or functions of the invention. Exemplary embodiments of components, arrangements, and configurations are described below to simplify the disclosure; however, these exemplary embodiments are provided merely as examples and are not intended to limit the scope of the invention. Additionally, the disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Finally, the exemplary embodiments presented below may be combined in any combination of ways, i.e., any element from one exemplary embodiment may be used in any other exemplary embodiment, without departing from the scope of the disclosure.

Deep-water floating systems for oil and gas could be the template for the concepts that are being developed for floating wind, but there can be a large difference between the scale that will be required. A single large floating system for oil and gas can achieve economic throughput of several million dollars per day, whereas each floating wind system will only generate roughly 15,000 to 20,000 dollars per day. Consequently, the number of platforms required will be much higher for floating systems for wind technology than floating systems for oil and gas. In order to achieve the scale required to amortize costs appropriately, floating wind projects are typically targeting 1 GigaWatt or similar capacity, which will require approximately sixty platforms.

Given that deep-water floating systems for oil and gas are typically manufactured over a several-year period of time with significant time/resources expended in design, manufacturing, assembly in a dry dock, transport on heavy-lift ships, and installation using dedicated installation vessels; it is clear that all of these phases can be improved to make repetitive, reduce the labor content and variability. It can therefore be seen that whereas the same concepts and techniques are a good starting point for floating wind, each phase of the process must be significantly more cost-effective.

In this disclosure, the entire process of delivery process of large-scale floating wind platforms is industrialized, with the following shortcomings addressed:
Engineering—oil and gas platforms typically are custom engineered for each platform;
Manufacturing—standard shipyard construction uses main steel and stiffening methods;
Assembly—joining sections is manpower intensive and is typically done in a dry dock, which limits the sizes of platforms and is very cost-intensive;
Transport—platforms are typically manufactured in Asia and then transported to either Europe or North America, where they will be deployed. Given the size of the platforms, limited numbers of platforms can be included on a single voyage;
Installation—large crane vessels are required to perform the installation of oil and gas process equipment. Specialized wind installation vessels are available but may have difficult interfaces with floating platforms due to the relative motions.

A high volume delivery system is preferable to be able to make floating wind technology economic, comprising the following components:
Standard design of sections, such as “cans” or “tubes,” comprising internal compartmentation (by watertight “decks”), rolled plate, and ring stiffeners. Standard details and standard designs reduce engineering costs. Rolling and welding techniques are more cost-effective than using main steel and stiffening methods.
Nearby manufacturing of sections, such as “cans” or “tubes,” can be used to provide the pre-assembled tubes to an assembly location that is closer to the planned installation point. The block of tubes can then be joined together at an assembly site that consists of a submersible barge or platform with several large cranes onboard. The floating systems can then be assembled on the barge or platform, which can then be submerged to float off. Because this assembly site can then be located close to where the installation can be done, it can both minimize the transportation costs to site and can also allow local workforces to perform the final assembly.
Simplified Framing and Manufacturing Methods, using the approaches that were pioneered by the Cell Spar and the Buoyant Tower, the framing of a floating system can be made to be much more repetitive and simpler than in a traditional floating system. The product variety is therefore reduced for the most part to Can Rolling, Ring T-Beam manufacture, and Bulkhead deck flat manufacture. This simpler framing, in combination with the modern trend of shipyard automation with offline programmed robotic welding allows the rapid industrialized process that can be used to produce these structures in bulk very rapidly.

Sections, such as ring stiffened cans, may be made by rolling a flat plate to the proper diameter. The individual ring sections can be manufactured in several methods, including rolling a split beam or by fabricating them. In either case, the outside dimension is important for the overall can manufacture because the sections are difficult to connect to each other if there are differences in the shape. If they are fabricated, keeping the required tolerances is easy, although, for the rolled method, it may be required to subsequently cut the outside diameter.

Single cans of large (e.g., up to and including approximately 40 feet in diameter) can be made with simple ring stiffening when the wall thicknesses are sufficiently large as well as when the T-beams have a sufficiently large section.

The framing of the pressure bulkheads is also important for the full automation of the manufacturing. The bulkhead girder depth is preferably less than 3 meters or 10 feet because this allows the bulkhead deck to be fully self-contained within a single can. If the structure needs to span between two cans, this can require significant manual labor to connect them together in an inconvenient orientation.

The manufacturing of the bulkheads can be automated and can comprise multiple main girders (four girders, for example) and can terminate in a single flat bar ring stiffener at the top of the structure.

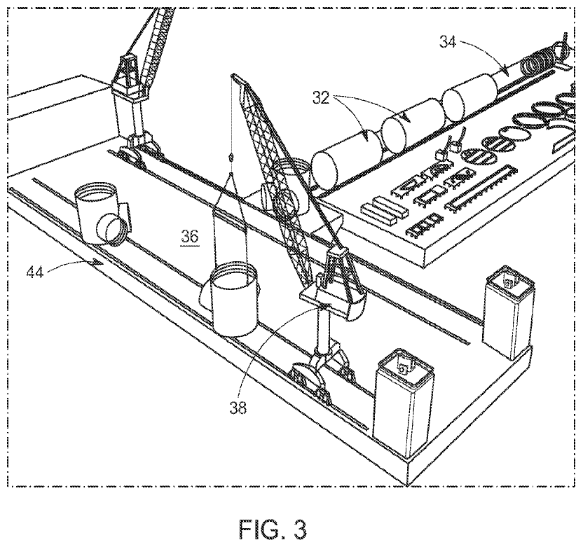

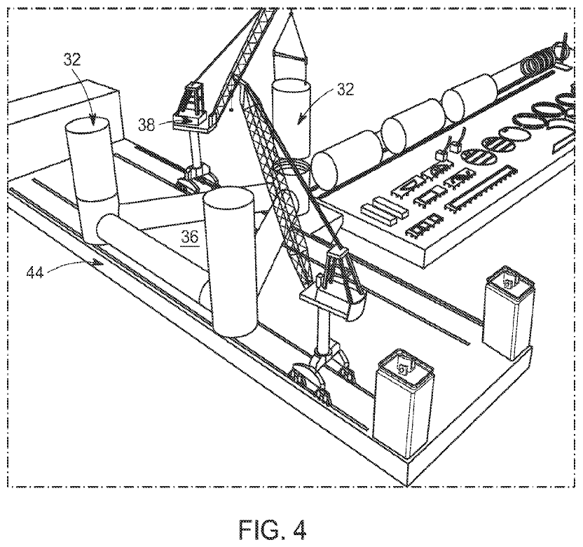

Using this framing, a facility can be designed that will produce a single vessel in a short amount of time, sufficiently quickly to facilitate serial production that is optimal for overall project cost. The target building is one pair of bulkheads a day with an additional 5 to 6 tubes. An anticipated cycle time for a semi-submersible can be approximately 3 to 5 days. Such a facility is shown, for example, in FIGS. 3 and 4.

This facility can either be built on land as a standard industrial facility, or it can be made compact for the purposes of deploying on a barge which can then be relocated to a location close to the ultimate deployment site. This is important because large-scale transportation from Asia or other locations can be cost-prohibitive if the individual structures are to be cost-effective enough for the economics of wind floating systems.

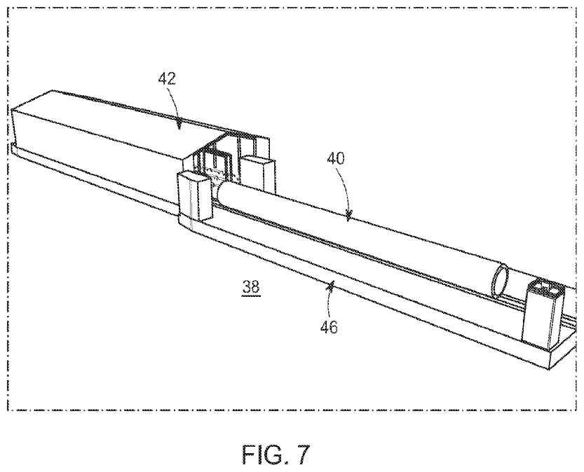

It is likely that the Tower (or similar) structure must be approximately 500 to 600 feet long, which means that some joining operations may be conducted outside of this facility, as is illustrated, for example, in FIG. 7.

The same components and delivery method can be used to manufacture semi-submersibles, as is illustrated, for example, in FIGS. 3 and 4. The columns and pontoons can all be made using the same tubular construction, with the pontoons coped to match the columns. A significant advantage of this design is that the wind platforms are driven by the overturning moment applied by the turbine in the most severe operating conditions. This moment can be accommodated by making the spacing of the columns much larger than can be accomplished in any but the largest dry docks, while being accessible to site.

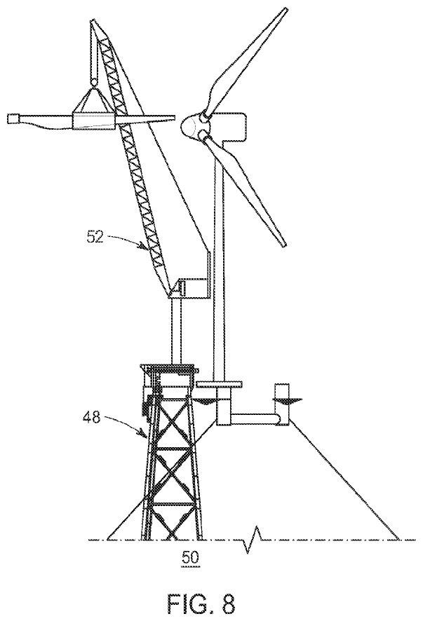

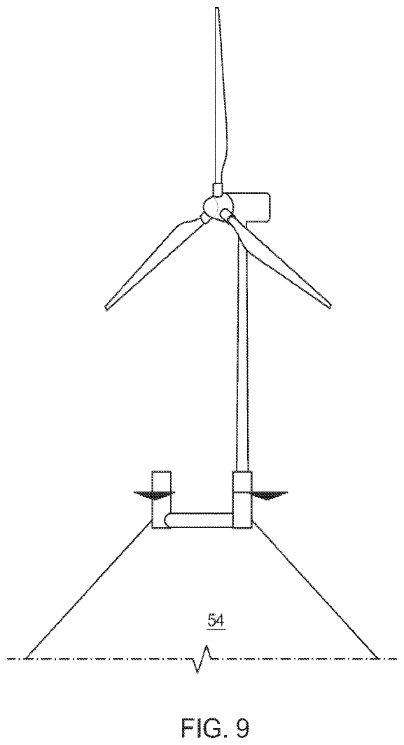

The nacelle and blades can be installed using a platform, such as either a standard jack-up installation vessel or a purpose-built crane jacket, as illustrated, for example, in FIG. 8.

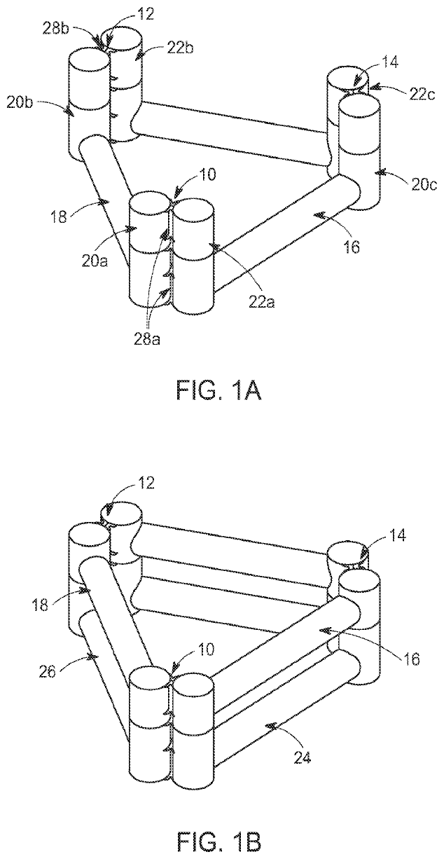

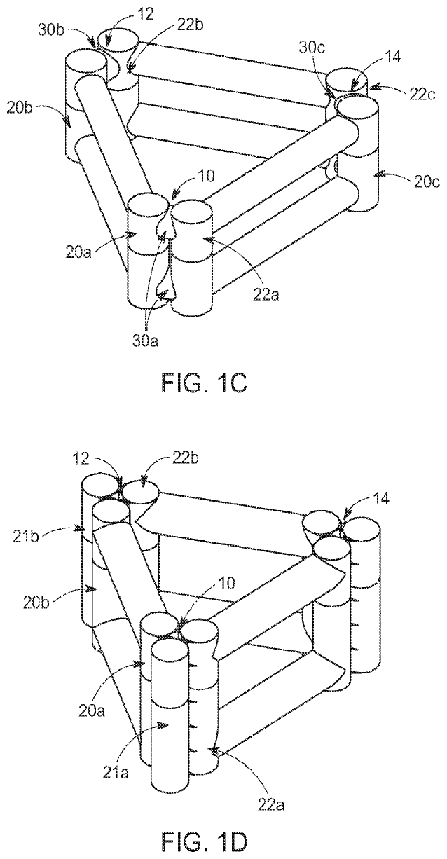

In reference to each of FIGS. 1a-1d, an example of a triangular semi-submersible is illustrated.

The semi-submersible includes a primary buoyant vertical column 10, and two secondary buoyant vertical columns 12 and 14. In subsequent steps, a Tower (not shown) is attached to the primary buoyant vertical column 10, preferably in such a way that the base of the Tower is located at least partially directly above the primary buoyant vertical column 10. At least two pontoons, such as 16 and 18, are made of a long horizontal tube that has a first end attached to the primary buoyant vertical column 10 near the floatation line of the semi-submersible. Each of the two pontoons 16, and 18 may be made using cans or tubes as previously described in the section Simplified Framing and Manufacturing Methods. Each of the two secondary buoyant vertical columns 12 and 14 is connected to a corresponding second end of one of the two pontoons 16 and 18. The primary buoyant vertical column 10 includes a pair of sections 20a and 22a that are offset laterally and connected by system 28a, including vertical shear plates and horizontal interstitial plates. The horizontal interstitial plates are “H” shaped. Each of the pair of sections 20a and 22a may also be made using cans or tubes. Similarly, each of the two secondary buoyant vertical columns 12 and 14 includes a pair of sections, respectively 20b and 22b, and 20c and 22c, that are offset laterally and may also be made using cans or tubes similarly connected.

In the examples of FIGS. 1b-1d, the semi-submersible further includes two long horizontal tubes, such as 26 and 24, each of which having a first end attached to the primary buoyant vertical column 10 below the floatation line of the semi-submersible. Each of the two secondary buoyant vertical columns 12 and 14 is further connected to a corresponding second end of one of the two long horizontal tubes 26 and 24.

In the example of FIG. 1c, the three pairs of sections, respectively 20a and 22a, 20b and 22b, and 20c and 22c, are connected by systems 30a, 30b and 30c. The systems 30a, 30b, and 30c include short horizontal tubes that are coped to match the outer surfaces of one of the pair of sections 20a and 22a, 20b and 22b, or 20c and 22c.

In the example of FIG. 1d, the primary buoyant vertical column 10, as well as each of the two secondary buoyant vertical columns 12 and 14, include three sections, 20a-c, 21a-c, and 22a-c, that are offset laterally and connected by systems such as shown in FIG. 1b or 1c. In general, any buoyant vertical column may include any number of sections that are offset laterally and closely connected.

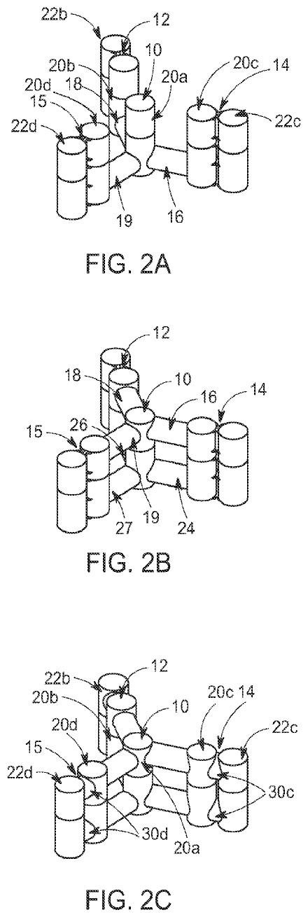

In reference to each of FIGS. 2a-2c, another example of a triangular semi-submersible is illustrated. In contrast with FIGS. 1a-1d, where the primary buoyant vertical column 10 is located at a corner of a triangular shape, the primary buoyant vertical column 10 is now located at or near the center of the triangular shape. Further, more secondary buoyant vertical columns, which are not used to connect a Tower, are provided, such as the secondary buoyant vertical columns 12, 14, and 15. In general, a semi-submersible may contain two or more secondary buoyant vertical columns arranged in a polygonal shape. Still further, the primary buoyant vertical column 10 may include a number of sections (e.g., only section 20a) that is different from the number of sections included in any of the secondary buoyant vertical columns (e.g., sections 20b-d and 22b-d, respectively).

FIGS. 3 and 4 illustrate a plurality of sections 32 that can be coupled together to form a semi-submersible. For example, the sections 32 comprise the cans or tubes previously described in the section Simplified Framing and Manufacturing Methods. The cans or tubes 32 can be manufactured at an inshore location in a facility provided on a barge 34. As used herein and in the appended claims, inshore generally means in protected waters, such as in a port at a quayside, or within several (i.e., less than ten) miles of the shoreline. This manufacturing site may be next to the first assembly site 36, where the semi-submersible is constructed, as shown in FIG. 1. Alternatively, the cans tubes can be transported from a more remote manufacturing site to the first assembly site 36 on a first barge. At this first assembly site 36, a second barge 44, which includes cranes 38, is provided.

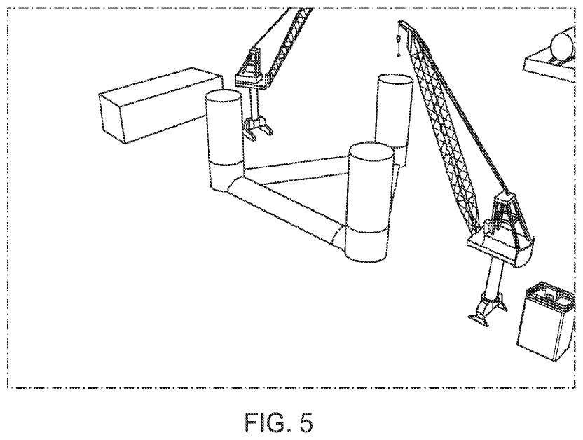

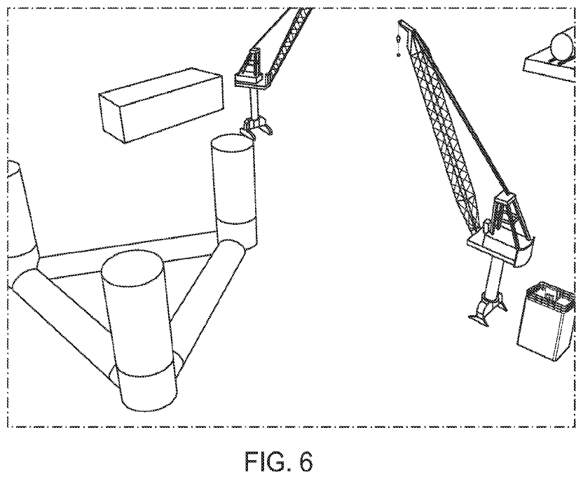

FIGS. 5 and 6 illustrate that the second barge 44 can be submerged to unload the semi-submersible. Thus, constructing the semi-submersible can be performed at least partially on a submersible barge 35 located inshore.

Alternatively, constructing the semi-submersible could be performed at least partially onshore in a shipyard, port, or at a quayside.

FIG. 7 illustrates a plurality of sections that can be coupled together in a production facility 42 located at another assembly site 38 to form a Tower hull 40. For example, the sections comprise the cans or tubes previously described in the section Simplified Framing and Manufacturing Methods. A major portion of the Tower hull 40 can be skidded out of the production facility 42 of the Tower hull to a barge 46 located at an assembly location. The major spar sections can be welded together on the barge 46. Also, the wind turbine can optionally be installed on the Tower.

Alternatively, the Tower may be manufactured in two steps, first by constructing flanged segments, and then assembling the segments together.

Once constructed, the semi-submersible and the Tower can be transported by barges to the vicinity of a platform 48 shown in FIG. 8. The platform 48 is at a second assembly site 50 that is located off-shore, where the barges are submerged so that the semi-submersible floats horizontally on the sea surface. The Tower is upended. The nacelle and blades are also transported to the platform 48 on barges. Prior to final installation at the wind farm, the wind turbine's nacelle and rotor blades are installed. In FIG. 8, the semi-submersible is releasably attached (e.g., tethered to the seafloor and/or to the platform) next to the platform 48. A lift structure 52 (e.g., a crane) on the platform 48 is used to mount the Tower, a nacelle, and blades on the semi-submersible. The Tower can be welded, grouted, flanged, etc., to the semi-submersible.

In order to avoid expensive floating lifting vessels with limited availability, as well as the technical difficulty of a floating-to-floating lift operation, it is preferred to utilize a platform structure, for example, a deep-water jacket structure, near the wind farm. Indeed, the change in draft during the operation can be substantial—chasing it down approximately 25 feet during the operation. The deep-water jacket structure can optionally be used later on for the transformation substation, wherein the off-shore substation is configured to collect and export the power generated by turbines through submarine cables. Of course, it is not always necessary that bottom fixed structures are preferred as transformer substations and also that a transformation is required due to the distance of the wind farm to the mainland.

In other embodiments, for the lift of the nacelle and rotor blades, a modular, self-erecting lift structure can alternatively be used, the construction of which is illustrated in U.S. application Ser. No. 17/672,674.

In other embodiments, for attaching the semi-submersible next to the platform, an installation base on the seafloor adjacent to the first off-shore location can alternatively be provided. The installation base is configured to be releasably connected to the semi-submersible.

Then the semi-submersible is detached, and the semi-submersible with the Tower, nacelle, and blades mounted thereon are towed vertically to a location where the off-shore wind turbine system is intended to be used (e.g., a wind farm), as is illustrated in FIG. 9. The completed floating turbine is stable with the nacelle and blades. The completed floating turbine can be towed vertically by tug boats to a final usage location 54 in the wind farm for mooring and power cable hook up. Mooring can optionally be performed using mooring lines and/or piles driven into the seafloor. However, in use, the semi-submersible may or may not be attached to a pile driven into the seafloor, and may or may not be moored.

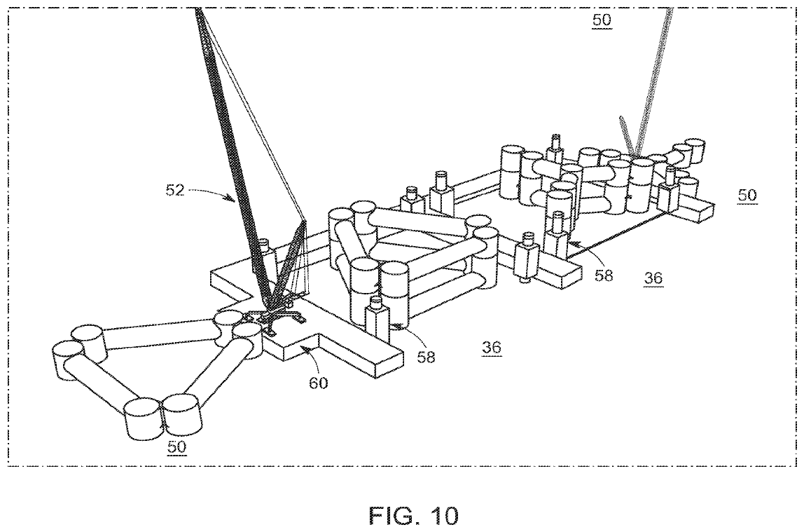

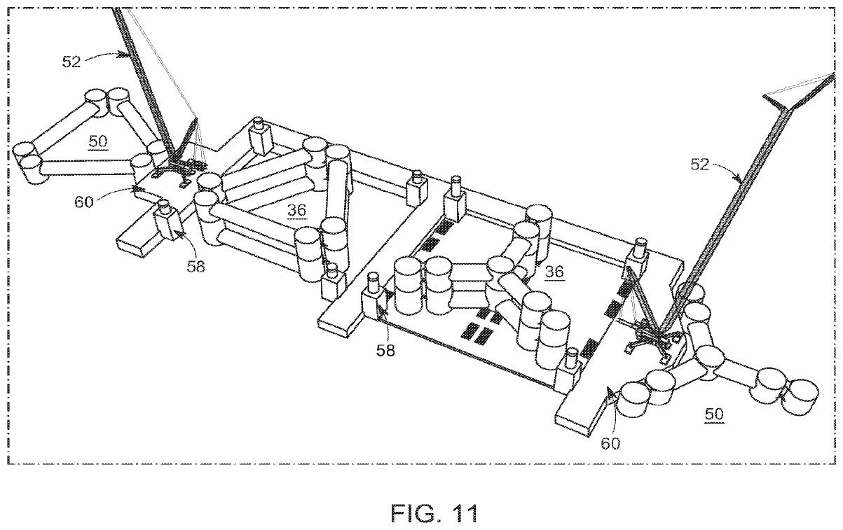

In reference to FIGS. 10 and 11, two views of an alternative embodiment are shown in which two first assembly sites 36, and two second assembly sites 50 are next to each other. The barge or platform 56 includes one or more elevator(s) 58 at each of the two first assembly sites 36, which are(is) used for raising or lowering a dry dock. The barge or platform 56 also includes one or more pier(s) 60 at each of the two second assembly sites 50. The one or more pier(s) 60 are suitably shaped to be adjacent to the primary buoyant vertical column of the semi-submersible, even in cases where the primary buoyant vertical column is located at or near the center of the semi-submersible. For example, one pier 60 is shown as triangular. At least one of a plurality of lift structures 52 is located on each of the piers 60 so that it is close to the primary buoyant vertical column to facilitate the placement of the Tower.

While FIGS. 10 and 11 show two first assembly sites 36 and two second assembly sites 50 that are configured for semi-submersibles that have different geometries, fewer or more first assembly sites, and second assembly sites may be provided next to one another, and the assembly sites may be configured for semi-submersibles that have the same geometry.

In addition to the foregoing, the disclosure also contemplates at least the following embodiments:

### Embodiment 1

Embodiment 1 is an off-shore wind turbine. The off-shore wind turbine generally comprises a semi-submersible, a tower attached to the semi-submersible, and a turbine mounted on top of the tower. For example, the semi-submersible may have a polygonal (e.g., triangular) shape when viewed from the top, and the side of the polygonal shape may be on the order of 200 to 250 feet long. The semi-submersible may have a height on the order of 100 to 150 feet. In use, a portion (e.g., approximately ⅔) of the height of the semi-submersible may be below the floatation line of the semi-submersible. The Tower may be approximately 500 to 600 feet long. The turbine may be housed in a nacelle, and blades (e.g., 3 blades) are connected to the turbine. The blades may be approximately 200 to 300 feet long.

Preferably, the semi-submersible and/or the Tower off-shore may be made by joining (e.g., welding) standard sections, such as tubes or cans, comprising a rolled plate and ring stiffeners, and in the cases of cans, bulkheads.

More particularly, the semi-submersible includes a primary buoyant vertical column. The primary buoyant vertical column may comprise one, two, three, or more stacks of standard sections closely connected side-by-side. The primary buoyant vertical column may be located at or near a corner of the polygonal shape of the semi-submersible, but preferably, the primary buoyant vertical column is located at or near the center of the polygonal shape. The semi-submersible further includes a first plurality of long horizontal tubes. Each of the first plurality of long horizontal tubes has a first end attached to the primary buoyant vertical column at a first level. The first level may be at or near the floatation line of the semi-submersible. The semi-submersible includes further includes a plurality of secondary buoyant vertical columns. Each of the plurality of secondary buoyant vertical columns is connected to a corresponding second end of one of the first plurality of long horizontal tubes.

Preferably, the Tower has a base that is located at least partially directly above the primary buoyant vertical column.

Spacings between the primary buoyant vertical columns and each of the plurality of secondary buoyant vertical columns are sufficiently large to accommodate an overturning moment applied by the turbine in operating conditions. For example, the spacings may be adjusted so that the hydrodynamic stiffnesses of the semi-submersible with respect to roll and pitch (i.e., the components of the matrix that specifies how the buoyancy load (i.e., moment) of the semi-submersible varies with roll and pitch when to the semi-submersible in its floating-at-rest configuration) is sufficiently large so that the moment generated by the wind pushing the turbine and applied to the semi-submersible via the Tower leads to a maximum roll and pitch angle of less 10 degrees, or alternatively a mean roll and pitch angle of approximately 4-5 degrees. A typical spacing between buoyant vertical columns when using buoyant vertical columns made of two cans having a diameter of 40 feet would be approximately 230 feet if the Tower is located at or near a corner of the semi-submersible and 135 feet if the Tower is located at or near the center of the semi-submersible.

### Embodiment 2

Embodiment 2 is an off-shore wind turbine as described in embodiment 1, wherein the primary buoyant vertical column and/or one or more of the plurality of secondary buoyant vertical columns include(s) a plurality of sections (preferably 2 or 3 sections), that are offset laterally, each of the plurality of sections including a cylindrical plate and a stiffening ring welded inside the cylindrical plate, and two bulkheads.

### Embodiment 3

Embodiment 3 is an off-shore wind turbine as described in embodiment 2, wherein any pair of the plurality of sections included in the primary buoyant vertical column or each in any of the plurality of secondary buoyant vertical columns is connected. Preferably, the connection is made with short horizontal tubes between the pair of sections. The short horizontal tubes are coped to match the outer surfaces of sections and welded to each section. The short horizontal tubes may be less than 10 feet long, such as approximately 5 feet long. However, in alternative embodiments, the connection may be made with vertical plates (e.g., shear plates) and horizontal plates (e.g., interstitial plates that are “H” shaped).

### Embodiment 4

Embodiment 4 is an off-shore wind turbine as described in any of embodiments 1 to 3, wherein the first plurality of long horizontal tubes includes (e.g., consists of) three long horizontal tubes distributed around the primary buoyant vertical column. The primary buoyant vertical column, and thus the Tower, may be located at or near the center of the semi-submersible. However, in alternative embodiments, the first plurality of long horizontal tubes may consist of two long horizontal tubes located on one side of the primary buoyant vertical column. The primary buoyant vertical column, and thus the Tower, may be located at or near a corner of the semi-submersible.

### Embodiment 5

Embodiment 5 is an off-shore wind turbine as described in embodiment 4, wherein the three long horizontal tubes are 120 degrees apart.

### Embodiment 6

Embodiment 5 is an off-shore wind turbine as described in any of embodiments 1 to 5, further comprising a second plurality of long horizontal tubes. Each of the second plurality of long horizontal tubes has a first end attached to the primary buoyant vertical column at a second level that may be either higher or lower than the first level, but is preferably lower than the first level and thus below the floatation line of the semi-submersible. Each of the plurality of secondary buoyant vertical columns is also connected to a corresponding second end of one of the second plurality of long horizontal tubes.

### Embodiment 7

Embodiment 7 is a method of installing an off-shore wind turbine.

Preferably, the method comprises the step of constructing a plurality of sections, each of the plurality of sections including a cylindrical plate and a stiffening ring welded inside the cylindrical plate, and two bulkheads.

The method comprises the step of constructing, at a first assembly site, a semi-submersible as described in any of embodiments 1 to 6. For example, the construction of the semi-submersible may be performed by welding together some of the plurality of sections.

Typically, the first assembly site is close to an off-shore usage location of the off-shore wind turbine. The first assembly site is configured to allow the lowering of the semi-submersible into the sea. For example, the first assembly site may include a submersible barge, or a platform, such as a standard jack-up vessel or a crane jacket having an elevator for raising or lowering a dry dock.

The method comprises the steps of lowering the semi-submersible so that the semi-submersible floats on the sea surface, towing the semi-submersible to a second assembly site next to a lift structure (e.g., a crane), and temporarily securing the semi-submersible next to the lift structure.

The method may comprise the step of constructing a Tower, typically at another assembly site. For example, the construction of the Tower may be performed by welding together other of the plurality of sections to form Tower segments terminated by flanges. The method may further comprise the steps of transporting (e.g., towing) the Tower segments to the second assembly site, and assembling (e.g., bolting) the Tower segments together.

The method comprises the steps of using the lift structure while the semi-submersible is temporarily secured to place a base of a Tower at least partially directly above the primary buoyant vertical column, attaching the Tower to the semi-submersible, and mounting a turbine on top of the semi-submersible.

The method comprises the steps of transporting the off-shore wind turbine system to the off-shore usage location, and coupling to the seafloor or mooring the off-shore wind turbine system at the off-shore usage location.

### Embodiment 8

Embodiment 8 is a method of installing an off-shore wind turbine as described in embodiment 7, wherein the plurality of sections is constructed on a barge.

### Embodiment 9

Embodiment 9 is a method of installing an off-shore wind turbine as described in embodiments 7 or 8, wherein the first assembly site includes a barge or a platform and a lift structure, and is configured to allow the lowering of the semi-submersible.

### Embodiment 10

Embodiment 10 is a method of installing an off-shore wind turbine as described in embodiment 9, wherein the second assembly site includes the barge or the platform and a plurality of lift structures. As such, the second assembly site is next to the first assembly site. The barge or the platform is used to temporarily secure the semi-submersible. Some of the plurality of lift structures may be used to construct the semi-submersible. Other of the plurality of lift structures may be used to place the base of the Tower at least partially directly above the primary buoyant vertical column and to mount the turbine on top of the semi-submersible.

### Embodiment 11

Embodiment 11 is a method of installing an off-shore wind turbine as described in embodiment 10, wherein the barge or the platform includes an elevator for raising or lowering a dry dock at the first assembly site and a pier at the second assembly site. At least one of the plurality of lift structures is located on the pier.

### Embodiment 12

Embodiment 12 is a method of installing an off-shore wind turbine as described in embodiment 11, wherein the pier is triangular. As such, the pier is suitably shaped to be adjacent to the primary buoyant vertical column in cases where the primary buoyant vertical column is located at or near the center of the semi-submersible, and the at least one of the plurality of lift structures that is located on the pier is close to the primary buoyant vertical column to facilitate the placement of the Tower.

### Embodiment 13

Embodiment 13 is an assembly facility. The assembly facility comprises a barge that is submersible for raising or lowering a dry dock at a first assembly site and a pier at a second assembly site. The assembly facility also comprises a plurality of lift structures mounted on the barge, wherein at least one of the plurality of lift structures is located on the pier. Optionally, the pier is triangular.

### Embodiment 14

Embodiment 14 is an assembly facility. The assembly facility comprises a platform, wherein the platform includes an elevator for raising or lowering a dry dock at a first assembly site and a pier at a second assembly site. The assembly facility also comprises a plurality of lift structures mounted on the platform, wherein at least one of the plurality of lift structures is located on the pier. Optionally, the pier is triangular.

### Embodiment 15

Embodiment 15 is an assembly facility as described in embodiment 14 or 15, wherein the assembly facility is adapted to assemble an off-shore wind turbine as described in any of embodiments 1 to 6, and/or to perform the method of installing an off-shore wind turbine as described in any of embodiments 7 to 12.

The invention is susceptible to various modifications and alternative forms, specific embodiments thereof are shown by way of example in the drawings and description. It should be understood, however, that the drawings and detailed description thereto are not intended to limit the invention to the particular form disclosed, but on the contrary, the intention is to cover all modifications, equivalents, and alternatives falling within the ordinary skill of a person to which the invention pertains.

What is claimed is:

1. An off-shore wind turbine, comprising:
a semi-submersible including a primary buoyant vertical column, a first plurality of long horizontal tubes, each having a first end attached to the primary buoyant vertical column at a first level, and a plurality of secondary buoyant vertical columns, each being connected to a corresponding second end of one of the first plurality of long horizontal tubes;
a tower attached to the semi-submersible, the tower having a base located at least partially directly above the primary buoyant vertical column; and
a turbine mounted on top of the tower;
wherein spacings between the primary buoyant vertical columns and each of the plurality of secondary buoyant vertical columns are sufficiently large to accommodate an overturning moment applied by the turbine in operating conditions.

2. The off-shore wind turbine of claim 1, wherein at least one of the plurality of secondary buoyant vertical columns includes a plurality of sections that are offset laterally, each of the plurality of sections including a cylindrical plate and a stiffening ring welded inside the cylindrical plate, and two bulkheads.

3. The off-shore wind turbine of claim 2, wherein short horizontal tubes coped to match outer surfaces of a pair of the plurality of sections connect the pair of the plurality of sections.

4. The off-shore wind turbine of claim 1, wherein the first plurality of long horizontal tubes includes three long horizontal tubes distributed around the primary buoyant vertical column.

5. The off-shore wind turbine of claim 4, wherein the three long horizontal tubes are one hundred and twenty degrees apart.

6. The off-shore wind turbine of claim 1, further comprising a second plurality of long horizontal tubes, each having a first end attached to the primary buoyant vertical column at a second level that is higher or lower than the first level, each of the plurality of secondary buoyant vertical columns being further connected to a corresponding second end of one of the second plurality of long horizontal tubes.

7. A method of installing an off-shore wind turbine, the method comprising:
constructing a plurality of sections, each of the plurality of sections including a cylindrical plate and a stiffening ring welded inside the cylindrical plate, and two bulkheads;
constructing a semi-submersible by welding together the plurality of sections at a first assembly site, the semi-submersible including a primary buoyant vertical column, a first plurality of long horizontal tubes, each having a first end attached to the primary buoyant vertical column at a first level, and a plurality of secondary buoyant vertical columns, each being connected to a corresponding second end of one of the first plurality of long horizontal tubes, wherein spacings between the primary buoyant vertical columns and each of the plurality of secondary buoyant vertical columns are sufficiently large to accommodate an overturning moment applied by the turbine in operating conditions;
lowering the semi-submersible so that the semi-submersible floats on the sea surface;
towing the semi-submersible to a second assembly site next to a lift structure;
temporarily securing the semi-submersible next to the lift structure;
using the lift structure to place a base of a tower at least partially directly above the primary buoyant vertical column;
attaching the tower to the semi-submersible while the semi-submersible is temporarily secured; and
mounting a turbine on top of the semi-submersible to form the off-shore wind turbine;
transporting the off-shore wind turbine to an off-shore usage location; and
coupling to the seafloor or mooring the off-shore wind turbine at the off-shore usage location.

8. The method of claim 7, wherein the plurality of sections is constructed on a barge.

9. The method of claim 7, wherein the first assembly site includes a barge or a platform and a lift structure, and is configured to allow the lowering of the semi-submersible.

10. The method of claim 9, wherein the second assembly site includes the barge or the platform and a plurality of lift structures.

11. The method of claim 10, wherein the barge or the platform includes an elevator for raising or lowering a dry dock at the first assembly site and a pier at the second assembly site, and wherein at least one of the plurality of lift structures is located on the pier.

12. The method of claim 11, wherein the pier is triangular.

13. The method of claim 12, wherein the first plurality of long horizontal tubes includes three long horizontal tubes distributed around the primary buoyant vertical column.

14. The method of claim 7, wherein constructing at least one of the plurality of secondary buoyant vertical columns includes coupling a plurality of sections that are offset laterally, each of the plurality of sections including a cylindrical plate and a stiffening ring welded inside the cylindrical plate, and two bulkheads.

15. The method of claim 7, wherein coupling the plurality of sections includes connecting short horizontal tubes coped to match outer surfaces of a pair of the plurality of sections to the pair of the plurality of sections.

16. An assembly facility, comprising:
a barge or platform, wherein either the barge is submersible for raising or lowering a dry dock at a first assembly site, or the platform includes an elevator for raising or lowering the dry dock at the first assembly site, and wherein the barge or platform includes a pier at a second assembly site; and
a plurality of lift structures mounted on the barge or platform, wherein at least one of the plurality of lift structures is located on the pier.

17. The assembly facility of claim 11, wherein the pier is triangular.
